(19) United States
(12) Patent Application Publication
(10) Pub. No.: US 2024/0174228 A1
(43) Pub. Date: May 30, 2024

(54) VEHICLE TRAVEL CONTROL DEVICE

(71) Applicants: TOYOTA JIDOSHA KABUSHIKI KAISHA, Toyota-shi (JP); DENSO CORPORATION, Kariya-city (JP)

(72) Inventors: Yuki KAWASAKI, Mishima-shi (JP); Takahiro SHIMIZU, Tokyo (JP)

(73) Assignees: TOYOTA JIDOSHA KABUSHIKI KAISHA, Toyota-shi (JP); DENSO CORPORATION, Kariya-city (JP)

(21) Appl. No.: 18/516,601

(22) Filed: Nov. 21, 2023

(30) Foreign Application Priority Data
Nov. 28, 2022 (JP) 2022-189314

(51) Int. Cl. B60W 30/14; B60W 30/16; G06V 20/58

(52) U.S. Cl. CPC B60W 30/143; B60W 30/16; G06V 20/584; B60W 2420/42; B60W 2420/52; B60W 2554/4045; B60W 2554/80; B60W 2556/40

(57) ABSTRACT

A vehicle travel control device comprising a surrounding information acquisition device that acquires information on targets around an own vehicle, and an electronic control unit configured to execute interruption acceptance control by acceleration/deceleration of the own vehicle so that an adjacent vehicle can interrupt in when it is determined that the adjacent vehicle is attempting to interrupt in front of the own vehicle by flashing blinkers based on the information on targets acquired by the surrounding information acquisition device, and the electronic control unit is configured to terminate the interruption acceptance control when it is determined that the adjacent vehicle is not executing the interruption and the adjacent vehicle has stopped blinking its blinkers in a situation where the interruption acceptance control is being executed.

### CROSS-REFERENCE TO RELATED APPLICATION

This application claims priority to Japanese Patent Application No. JP2022-189314 filed on Nov. 28, 2022, the content of which is hereby incorporated by reference in its entirety into this application.

### BACKGROUND

### 1. Technical Field

The present disclosure relates to a travel control device for a vehicle such as an automobile.

### 2. Description of the Related Art

Another vehicle (hereinafter referred to as the “adjacent vehicle”) traveling in the same direction as a vehicle (hereinafter referred to as “own lane”) in a lane adjacent to the lane in which the own vehicle is traveling may interrupt in front of the own vehicle by changing lanes. It is known to control acceleration and deceleration of the own vehicle so that the adjacent vehicle can safely interrupt the own vehicle as a way of controlling the own vehicle to cope with such an interruption by the adjacent vehicle.

A travel control device is described in Japanese Patent No. 06897170 that is configured to control acceleration and deceleration of an own vehicle so that an adjacent vehicle can safely interrupt in front of the own vehicle when it is determined that there is a request for the adjacent vehicle to interrupt into an own lane by means of flashing blinker lamps, etc. In this travel control device, when the interruption of the adjacent vehicle is completed, the control of the acceleration/deceleration of the own vehicle for the interruption of the adjacent vehicle ends. Incidentally, in this application, blinker lamps are abbreviated as blinkers.

Generally, a driver who intends to change lanes indicates his or her intention to change lanes to surrounding vehicles by flashing blinkers prior to changing lanes. However, before starting to change lanes or while changing lanes, the driver may withdraw his or her intention to change lanes and turn off the blinkers.

In the travel control device described in the above Japanese Patent, it is not assumed that the intention to change lanes may be withdrawn and blinkers are turned off before starting the lane change or during the lane change. Therefore, when blinkers are turned off, the control of the acceleration/deceleration of the own vehicle for the interruption of the adjacent vehicle cannot be appropriately terminated.

### SUMMARY

The present disclosure provides a travel control device that is configured to control acceleration/deceleration of an own vehicle so that an adjacent vehicle can safely interrupt in front of the own vehicle, and is improved so that the acceleration/deceleration of the own vehicle can be terminated when the adjacent vehicle stops interrupting.

According to the present disclosure, a vehicle travel control device is provided that comprises a surrounding information acquisition device that acquires information on targets around an own vehicle, and an electronic control unit configured to execute interruption acceptance control by acceleration/deceleration of the own vehicle so that an adjacent vehicle can interrupt in when it is determined that the adjacent vehicle traveling in an adjacent lane is attempting to interrupt in front of the own vehicle by flashing blinkers based on the information on targets acquired by the surrounding information acquisition device.

The electronic control unit is configured to terminate the interruption acceptance control when it is determined that the adjacent vehicle is not executing interruption and the adjacent vehicle has stopped blinking the blinkers in a situation where the interruption acceptance control is being executed.

According to the above configuration, when it is determined that the adjacent vehicle has not executed the interruption and the adjacent vehicle has stopped blinking the blinkers in a situation where the interruption acceptance control is being executed, the interruption acceptance control is ended.

Therefore, when an intention to change lanes is withdrawn and the blinkers are turned off before starting a lane change or while changing lanes, the interruption acceptance control can be terminated. In addition, as compared to where the interruption acceptance control is terminated when it is determined that the adjacent vehicle is not executing the interruption or when it is determined that the adjacent vehicle has stopped flashing the blinkers, it is possible to accurately determine whether or not the intention to change lanes has been withdrawn. Therefore, it is possible to reduce the possibility that the interruption acceptance control may be terminated unnecessarily.

In one aspect of the present disclosure, the electronic control unit is configured to terminate the interruption acceptance control when it is determined that the adjacent vehicle is not executing the interruption, the adjacent vehicle has turned off the blinkers, and a time for which the interruption acceptance control is being executed is equal to or greater than a reference value, in the situation where the interruption acceptance control is executed.

Therefore, as compared to where it is not determined whether or not the time for which the interruption acceptance control is being executed is equal to or greater than the reference value, it is possible to determine with even higher accuracy whether or not the intention to change lanes has been withdrawn. Therefore, it is possible to further reduce the possibility that the interruption acceptance control may be ended unnecessarily.

In another aspect of the present disclosure, the electronic control unit is configured to execute follow-up inter-vehicle distance control after terminating the interruption acceptance control.

According to the above aspect, when the interruption acceptance control is terminated, the follow-up inter-vehicle distance control is executed. Therefore, when the interruption acceptance control is terminated, the follow-up inter-vehicle distance control can be executed, so that, even if there is a preceding vehicle in front of the own vehicle, it is possible to prevent the own vehicle from approaching the preceding vehicle excessively.

Further, in another aspect of the present disclosure, the electronic control unit is configured to acquire map information, and is configured to continue the interruption acceptance control when it is determined, based on the map information, that a lane in which the adjacent vehicle is traveling merges into a lane in which the own vehicle is traveling within a predetermined range in front of the own vehicle, even if it is determined that the adjacent vehicle is not executing the interruption and the adjacent vehicle has stopped blinking the blinkers in a situation where the interruption acceptance control is being executed.

According to the above aspect, even if it is determined that the adjacent vehicle has not executed the interruption and the adjacent vehicle has stopped flashing its blinkers in a situation where the interruption acceptance control is being executed, when it is determined that the lane in which the adjacent vehicle is traveling merges into the own lane in which the own vehicle is traveling within the predetermined range in front of the own vehicle, the interruption acceptance control is continued.

Therefore, as compared to where the interruption acceptance control is not continued, it is possible to safely cause the adjacent vehicle to interrupt in front of the own vehicle as the lanes merge.

Further, in another aspect of the present disclosure, the electronic control unit is configured to execute acceleration/deceleration control of the own vehicle when it is determined that the adjacent vehicle is attempting to interrupt into the lane in which the own vehicle is traveling by flashing the blinkers and it is determined that a relative speed and a relative distance of the adjacent vehicle to the own vehicle are within a preset interruption allowable range.

According to the above aspect, when it is determined that the adjacent vehicle is attempting to interrupt into the lane in which the own vehicle is traveling by flashing the blinkers and it is determined that a relative speed and a relative distance of the adjacent vehicle to the own vehicle are within the preset interruption allowable range, the acceleration/deceleration control of the own vehicle is executed.

Therefore, as compared to where it is not determined whether or not a relative speed and a relative distance of the adjacent vehicle to the own vehicle are within the preset interruption allowable range, the adjacent vehicle can safely interrupt in front of the own vehicle.

Further, in another aspect of the present disclosure, the electronic control unit is configured to determine that the relative speed and the relative distance are within the preset interruption allowable range when the relative distance is equal to or greater than a reference relative distance, and the reference relative distance is set to be a positive value when the relative speed is less than a negative reference value, and to be a negative value when the relative speed is equal to or greater than the reference value, and so that the smaller the relative speed is, the larger the reference relative distance is.

According to the above aspect, when the relative distance is equal to or greater than a reference relative distance, it is determined that the relative speed and the relative distance are within the preset interruption allowable range. The reference relative distance is set to be a positive value when the relative speed is less than a negative reference value, and to be a negative value when the relative speed is equal to or greater than the reference value, and so that the smaller the relative speed is, the larger the reference relative distance is.

Therefore, when the vehicle speed of the own vehicle is higher than the vehicle speed of the adjacent vehicle and the relative speed is less than the reference value, unless the adjacent vehicle is located ahead of the own vehicle and the relative distance is large, it is not determined that the relative speed and the relative distance are within the preset interruption allowable range. Therefore, the adjacent vehicle can safely interrupt in front of the own vehicle.

Furthermore, when the relative speed is a negative value, the reference relative distance is set to increase as the absolute value of the relative speed increases, so that the greater the difference between a vehicle speed of the own vehicle and a vehicle speed of the adjacent vehicle, the greater a distance that the adjacent vehicle must be located in front of the own vehicle. Therefore, for example, as compared to where the reference relative distance is constant regardless of a magnitude of the difference between the vehicle speed of the own vehicle and the vehicle speed of the adjacent vehicle, the adjacent vehicle can safely interrupt in front of the own vehicle.

The reference relative distance is set to have a negative value when the relative velocity is equal to or greater than the reference value, and is set such that the greater the relative velocity, the greater the absolute value of the reference relative distance. Therefore, when the vehicle speed of the own vehicle is lower than the vehicle speed of the adjacent vehicle, it is determined that the relative speed and relative distance are within the preset interruption allowable range even if the adjacent vehicle is not located ahead of the own vehicle. Accordingly, as compared to where acceleration/deceleration control of the own vehicle is not executed if the adjacent vehicle is not located ahead of the own vehicle, acceleration/deceleration control of the own vehicle can be started earlier.

The greater the difference between the vehicle speed of the own vehicle and the vehicle speed of the adjacent vehicle, the greater the distance that the adjacent vehicle may be located behind the own vehicle.

Therefore, for example, as compared to where the reference relative distance is constant regardless of the magnitude of the difference between vehicle speed of the own vehicle and the vehicle speed of the adjacent vehicle, the adjacent vehicle can start preparing to interrupt in front of the own vehicle earlier.

Notably, in this application, when the vehicle speed of the own vehicle is lower than the vehicle speed of the adjacent vehicle, the relative speed is a negative value, and when the adjacent vehicle is located behind the own vehicle, the relative distance is a negative value.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing an embodiment of a vehicle travel control device according to the present disclosure.

FIG. 2 is a flowchart showing a travel control routine in the embodiment.

FIG. 3 is a diagram showing an interruption allowable range regarding a relative speed Vr and a relative distance Dr of an adjacent vehicle with respect to an own vehicle.

FIG. 4 is a diagram for explaining acceleration/deceleration control of the own vehicle in a situation where a vehicle speed Vo of the own vehicle is higher than a vehicle speed Va of the adjacent vehicle.

FIG. 5 is a diagram for explaining acceleration/deceleration control of the own vehicle in a situation where the vehicle speed Vo of the own vehicle is lower than the vehicle speed Va of the adjacent vehicle.

FIG. 6 is a diagram for explaining an operation of the embodiment in comparison with a prior art in a situation where the vehicle speed of the own vehicle is higher than the vehicle speed of the adjacent vehicle.

FIG. 7 is a diagram for explaining an operation of the embodiment in comparison with a prior art in a situation where the vehicle speed of the own vehicle is lower than the vehicle speed of the adjacent vehicle.

### DETAILED DESCRIPTION

A vehicle travel control device according to an embodiment of the present disclosure will be described in detail below with reference to the accompanying drawings.

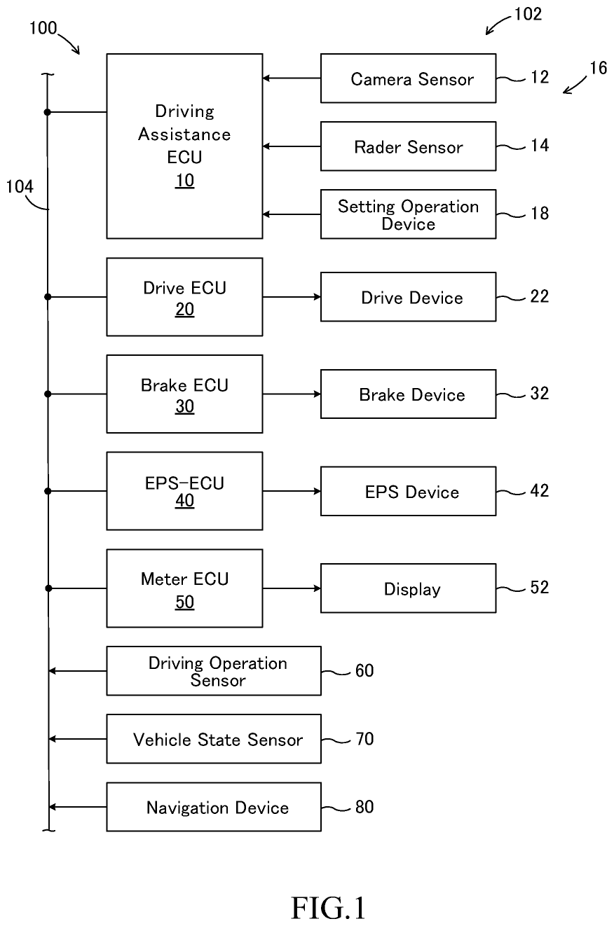

As shown in FIG. 1, a vehicle travel control device 100 according to an embodiment of the present disclosure is applied to a vehicle 102 and includes a driving assistance ECU 10. The vehicle 102 may be a vehicle capable of autonomous driving. As shown in FIG. 1, the vehicle 102 includes a drive ECU 20, a brake ECU 30, an electric power steering ECU 40, and a meter ECU 50. ECU means an electronic control unit having a microcomputer as its main part. In the following description, the vehicle 102 is referred to as own vehicle 102 as necessary to distinguish it from other vehicles, and the electric power steering will be referred to as EPS.

A microcomputer of each ECU includes a CPU, a ROM, a RAM, a readable and writable nonvolatile memory (N/M), an interface (I/F), and the like. The CPU implements various functions by executing instructions (programs, routines) stored in the ROM. Furthermore, these ECUs are connected to each other via a CAN (Controller Area Network) 104 so as to be able to exchange data (communicate). Therefore, detected values of sensors (including switches) connected to a specific ECU are transmitted to other ECUs as well.

The driving assistance ECU 10 is a central control unit that performs vehicle travel control such as follow-up inter-vehicle distance control and lane keeping control. In the embodiment, the driving assistance ECU 10 cooperates with other ECUs to perform vehicle travel control including adjacent vehicle interruption acceptance control and follow-up inter-vehicle distance control, as will be described in detail later. In the following description, the follow-up inter-vehicle distance control will be referred to as ACC (adaptive cruise control).

Camera sensors 12 and radar sensors 14 are connected to the driving assistance ECU 10. The camera sensors 12 and the radar sensors 14 include a plurality of camera devices and a plurality of radar devices, respectively. The camera sensors 12 and the radar sensors 14 function as a surrounding information acquisition device 16 that acquires information such as targets around the vehicle 102.

Although not shown in the figure, each camera device of the camera sensors 12 includes a camera unit that captures images of surroundings of the vehicle 102, and a recognition unit that analyzes the image data captured by the camera unit and recognizes targets such as white lines on a road and other vehicles. The recognition unit supplies information about a recognized target to the driving assistance ECU 10 every time a predetermined time elapses.

Each radar device of the radar sensors 14 has a radar transmitting/receiving unit and a signal processor (not shown). The radar transmitting/receiving unit emits radio waves in the millimeter wave band (hereinafter referred to as “millimeter waves”) around the vehicle 102, and three-dimensional objects (for example, other vehicles, bicycles, guardrails, etc.) existing within a radiation range, and receives reflected millimeter waves (i.e., reflected waves). Based on a phase difference between the emitted millimeter wave and the received reflected wave, an attenuation level of the reflected wave, and a time from when the millimeter wave is emitted to when the reflected wave is received, the signal processing unit acquires every predetermined time information concerning a relative distance and a relative speed between the own vehicle and a three-dimensional object, a relative position (direction) of the three-dimensional object with respect to the own vehicle, and the like, and supplies the information to the driving assistance ECU 10. LIDAR (Light Detection And Ranging) may be used instead of or in addition to the radar sensor 14.

Further, a setting operation device 18 is connected to the driving assistance ECU 10, and the setting operation device 18 is provided at a position to be operated by a driver. Although not shown in FIG. 1, the setting operation device 18 includes an ACC switch and a setting device for setting an ACC target vehicle speed Vt and a target inter-vehicle time Tt, which will be described later. The driving assistance ECU 10 executes vehicle travel control when the ACC switch is on.

The drive ECU 20 is connected to a drive device 22 that accelerates the vehicle 102 by applying driving force to drive wheels (not shown in FIG. 1). The drive ECU 20 normally controls the drive device 22 so that the driving force generated by the drive device 22 changes according to the driving operation by the driver, and when the drive ECU 20 receives a command signal from the driving assistance ECU 10, the drive ECU 20 controls the drive device 22 based on the command signal.

Note that the drive device 22 is not limited to a combination of an internal combustion engine and an automatic transmission. That is, the drive device 22 may be any drive device known in the art such as a combination of an internal combustion engine and a continuously variable transmission, a so-called hybrid system that is a combination of an internal combustion engine and a motor, a so-called plug-in hybrid system, a combination of a fuel cell and a motor, or a motor.

The brake ECU 30 is connected to a brake device 32 that decelerates the vehicle 102 by applying braking force to wheels (not shown in FIG. 1). The brake ECU 30 normally controls the brake device 32 so that a braking force generated by the brake device 32 changes according to a braking operation by the driver, and, when the brake ECU 30 receives a command signal from the driving assistance ECU 10, the brake ECU 30 performs automatic braking by controlling the brake device 32 based on a command signal.

An EPS device 42 is connected to the EPS-ECU 40. The EPS-ECU 40 controls the EPS device 42 in a manner known in the art based on a steering torque Ts and a vehicle speed V detected by a driving operation sensor 60 and a vehicle state sensor 70, which will be described later, to control the steering torque and reduce the driver's steering burden. Further, the EPS-ECU 40 can steer steered wheels as necessary by controlling the EPS device 42. Therefore, the EPS-ECU 40 and the EPS device 42 function as an automatic steering device that automatically steers the steered wheels as necessary.

A display 52 is connected to the meter ECU 50. The display 52 may be, for example, a head-up display or a multi-information display that displays meters and various piece of information, or may be a display of a navigation device.

The driving operation sensor 60 and the vehicle state sensor 70 are connected to the CAN 104. Information detected by the driving operation sensor 60 and the vehicle state sensor 70 (referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a driving operation amount sensor and a braking operation amount sensor. Further, the driving operation sensor 60 includes a steering angle sensor, a steering torque sensor, and the like. The vehicle state sensor 70 includes a vehicle speed sensor, a longitudinal acceleration sensor, a lateral acceleration sensor, a yaw rate sensor, and the like.

As is well known, ACC includes two types of control: constant speed traveling control and preceding vehicle following control. The constant speed traveling control is a control that adjusts a braking/driving force of the vehicle 102 so that a vehicle speed V of the vehicle conforms to a target vehicle speed (set speed) Vt without requiring any braking/driving operation by the driver. Preceding vehicle following control is a control that causes the own vehicle to follow a preceding vehicle while maintaining a inter-vehicle distance D between the preceding vehicle (following target vehicle) and the own vehicle 102 at a target inter-vehicle distance Dt without requiring any braking/driving operation by the driver.

Furthermore, a navigation device 80 is also connected to the CAN 104. The navigation device 80 includes a GPS receiver that detects a position of the vehicle 102, a storage device that stores map information, and a communication device that acquires a latest map information from outside. The navigation device 80 functions as a device that acquires information on a current position of the vehicle 102, and outputs a signal indicating the current position of the vehicle on a map and map information of its surroundings to the driving assistance ECU 10.

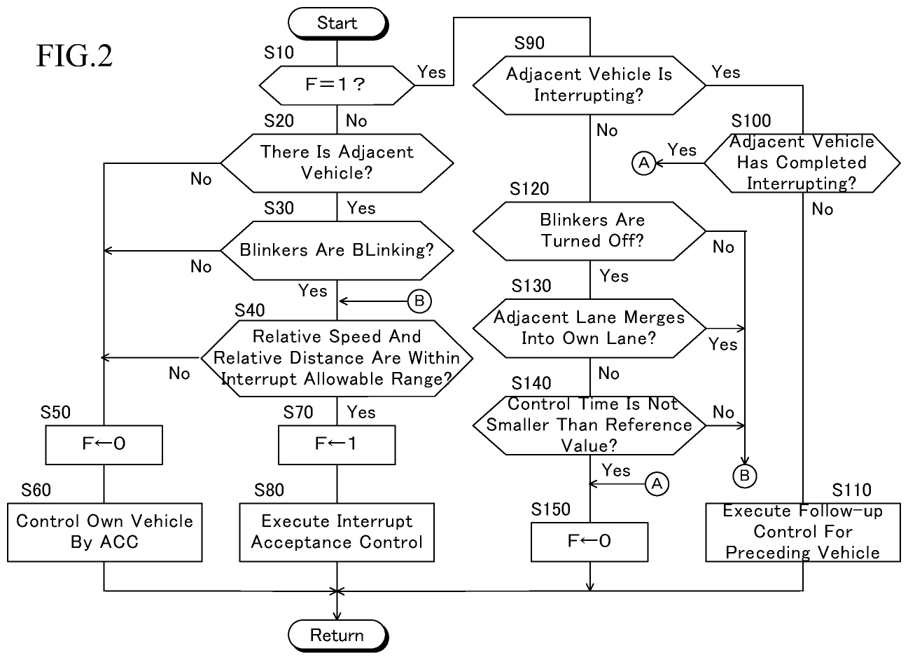

In the embodiment, the ROM of the driving assistance ECU 10 stores a vehicle travel control program corresponding to the flowchart shown in FIG. 2, and the CPU executes the vehicle travel control according to the program.

### Vehicle Travel Control Routine in the Embodiment

Next, the vehicle travel control routine in the embodiment will be described with reference to the flowchart shown in FIG. 2. The vehicle travel control according to the flowchart shown in FIG. 2 is executed by the CPU of the driving assistance ECU 10 when the ACC switch (not shown in FIG. 1) is turned on. In the following description, the vehicle travel control will be referred to as present control.

First, in step S10, the CPU determines whether or not flag F is 1, that is, whether or not the own vehicle is under control to accept an interruption of an adjacent vehicle. When an affirmative determination is made, the present control proceeds to step S90, and when a negative determination is made, the present control proceeds to step S20. Note that the flag F is initialized to 0 at the start of the present control according to the flowchart shown in FIG. 2.

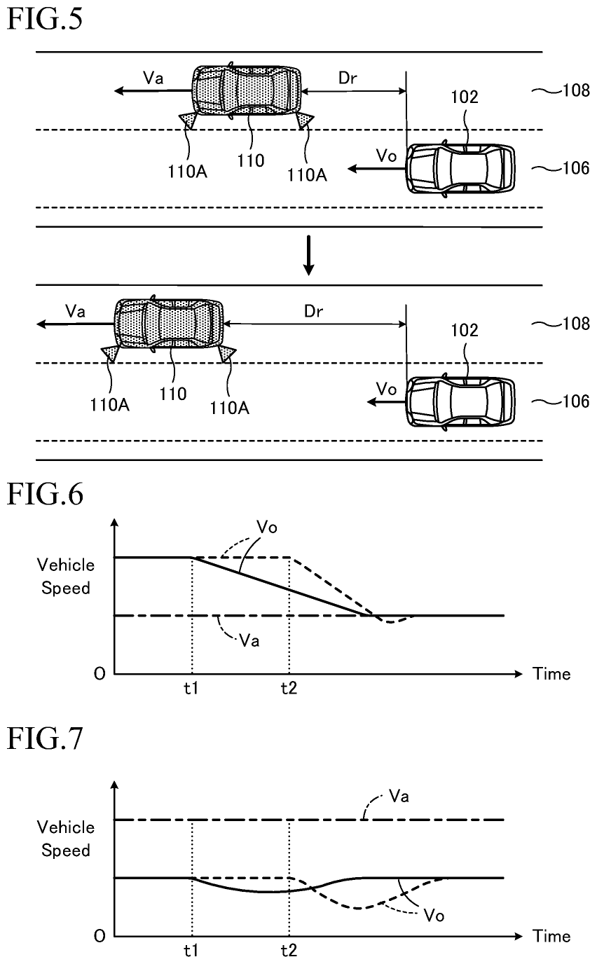

In step S20, the CPU determines whether or not there is an adjacent vehicle 110 traveling in the same direction as the own vehicle in a lane 108 adjacent to the own lane 106, as shown in FIGS. 4 and 5, for example, based on the information on targets acquired by the surrounding information acquisition device 16. When a negative determination is made, the present control proceeds to step S50, and when an affirmative determination is made, the present control proceeds to step S30.

In step S30, the CPU determines whether or not blinkers 110A of the adjacent vehicle 110 on the own vehicle side are blinking based on the information on targets acquired by the surrounding information acquisition device 16. When a negative determination is made, the present control proceeds to step S50, and when an affirmative determination is made, the present control proceeds to step S40.

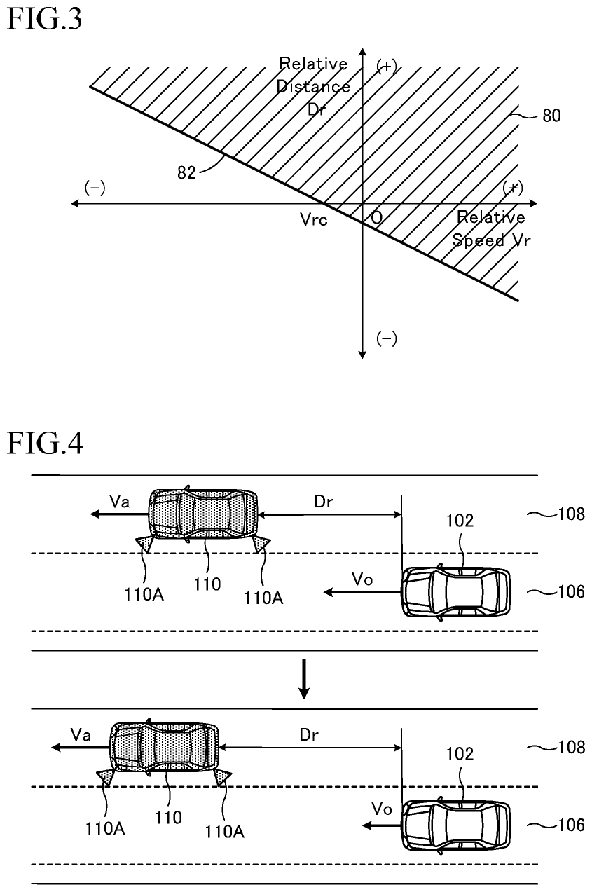

In step S40, the CPU calculates a relative speed Vr and a relative distance Dr of the adjacent vehicle with respect to the own vehicle 102 based on the information on targets acquired by the surrounding information acquisition device 16, and determines whether or not the relative speed Vr and the relative distance Dr are within the interruption allowable range 80 shown in FIG. 3. When a negative determination is made, the flag F is reset to 0 in step S50, and the own vehicle is controlled by ACC, that is, the constant speed traveling control or the preceding vehicle following control is executed in step S60. On the other hand, when an affirmative determination is made, flag F is set to 1 in step S70. Note that when flag F is 0, flag F is maintained at 0 in step S50.

Therefore, as compared to where it is not determined whether or not a relative speed Vr and a relative distance Dr of the adjacent vehicle to the own vehicle are within the preset interruption allowable range 80, the adjacent vehicle can safely interrupt in front of the own vehicle.

As shown by hatching in FIG. 3, the interruption allowable range 80 is a range in which the relative distance Dr is equal to or greater than a reference relative distance 82. The reference relative distance 82 is a positive value when the relative velocity Vr is less than a negative reference value Vrc, and a negative value when the relative velocity Vr is equal to or greater than the reference value Vrc. The reference relative distance 82 is set to increase as the relative velocity Vr decreases.

In other words, the reference relative distance 82 is set so that when the relative distance Dr is a positive value, the larger an absolute value of the relative velocity Vr is, the larger the reference relative distance is, and when the relative velocity Vr is a positive value, the larger the relative velocity is, the more negative the reference relative distance is, and the larger the absolute value thereof. Further, the reference relative distance 82 is set such that when the relative distance Dr and the relative velocity Vr are negative values, the larger the absolute value of the relative velocity is, the smaller the absolute value of the reference relative distance that is a negative value. It is considered that the larger the relative distance Dr is than the reference relative distance 82 and the larger the difference between the relative distance Dr and the reference relative distance 82, the higher the safety when an adjacent vehicle interrupts in front of the own vehicle.

Therefore, when the vehicle speed of the own vehicle is higher than a vehicle speed of the adjacent vehicle and the relative speed Vr is less than the reference value Vrc, unless the adjacent vehicle is located ahead of the own vehicle and the relative distance Dr is large, it is not determined that the relative speed and the relative distance are within the preset interruption allowable range. Therefore, the adjacent vehicle can safely interrupt in front of the own vehicle.

Furthermore, when the relative speed Vr is a negative value, the reference relative distance 82 is set to increase as the absolute value of the relative speed increases, so that the larger the difference between a vehicle speed of the own vehicle and a vehicle speed of the adjacent vehicle, the larger a distance that the adjacent vehicle must be located in front of the own vehicle. Therefore, for example, as compared to where the reference relative distance is constant regardless of a magnitude of the difference between the vehicle speed of the own vehicle and the vehicle speed of the adjacent vehicle, the adjacent vehicle can safely interrupt in front of the own vehicle.

The reference relative distance 82 is set to have a negative value when the relative velocity Vr is equal to or greater than the reference value Vrc, and is set such that the larger the relative velocity, the larger the absolute value of the reference relative distance. Therefore, when the vehicle speed of the own vehicle is lower than the vehicle speed of the adjacent vehicle, it is determined that the relative speed and relative distance are within the preset interruption allowable range even if the adjacent vehicle is not located ahead of the own vehicle. Accordingly, as compared to where the acceleration/deceleration control of the own vehicle is not executed if the adjacent vehicle is not located ahead of the own vehicle, the acceleration/deceleration control of the own vehicle can be started earlier.

The larger the difference between the vehicle speed of the own vehicle and the vehicle speed of the adjacent vehicle, the larger the distance that the adjacent vehicle may be located behind the own vehicle. Therefore, for example, as compared to where the reference relative distance is constant regardless of the magnitude of the difference between vehicle speed of the own vehicle and the vehicle speed of the adjacent vehicle, the adjacent vehicle can start preparing to interrupt in front of the own vehicle earlier.

In step S80, the CPU executes the interruption acceptance control by accelerating and decelerating the own vehicle so as to accept an interruption by the adjacent vehicle into the own lane. For example, as shown in FIG. 4, when the vehicle speed Vo of the own vehicle 102 is higher than the vehicle speed Va of the adjacent vehicle 110 and the relative speed Vr is a negative value, by decelerating the own vehicle so that the relative speed Vr becomes a positive value, for example, the vehicle speed Vo is decreased and the relative distance Dr is increased. Notably, a degree of decrease in vehicle speed Vo may be smaller as the relative distance Dr becomes larger.

On the other hand, as shown in FIG. 5, when the vehicle speed Vo of the own vehicle 102 is lower than the vehicle speed Va of the adjacent vehicle 110 and the relative speed Vr is a positive value, the acceleration and deceleration of the own vehicle is controlled so that a space (sufficient relative distance Dr) for the adjacent vehicle to safely interrupt in front of the own vehicle is secured.

In step S90, the CPU determines whether or not the adjacent vehicle is interrupting into the own lane based on the information on targets acquired by the surrounding information acquisition device 16. When a negative determination is made, the control proceeds to step S120, and when an affirmative determination is made, the control proceeds to step S100.

In step S100, the CPU determines whether or not the adjacent vehicle has completed interrupting into the own lane based on the information on targets acquired by the surrounding information acquisition device 16. When an affirmative determination is made, the present control proceeds to step S150, and when a negative determination is made, the present control proceeds to step S110. Note that when the adjacent vehicle is traveling within the range of the own lane, it may be determined that the adjacent vehicle has completed interrupting into the own lane.

In step S110, the CPU executes preceding vehicle follow-up control using the adjacent vehicle executing the interruption as the preceding vehicle. Note that when the adjacent vehicle approaches the center of the own lane, it may be determined that the adjacent vehicle is interrupting into the own lane.

In step S120, the CPU determines whether or not the blinkers on the own vehicle side of the adjacent vehicle are turned off based on the information on targets acquired by the surrounding information acquisition device 16. When a negative determination is made, the present control proceeds to step S40, and when an affirmative determination is made, the present control proceeds to step S130. Note that an affirmative determination is also made when it is determined that the adjacent vehicle has stopped flashing the blinkers (their lights have gone out), and then the blinkers of the adjacent vehicle cannot be recognized due to intervention of a following vehicle or the like.

In step S130, the CPU acquires map information from the navigation device 80, and based on the map information, determines whether or not a lane in which the adjacent vehicle is running merges into the own lane in which the own vehicle is running within a predetermined range in front of the own vehicle. When an affirmative determination is made, the present control proceeds to step S40, and when a negative determination is made, the present control proceeds to step S140.

In step S140, the CPU determines whether or not an elapsed time since the start of the interruption acceptance control in step S80 is equal to or greater than a reference value (a preset positive constant). When a negative determination is made, the present control proceeds to step S40, and when an affirmative determination is made, the flag F is reset to 0 in step S150.

### Operation of the Embodiment

Next, the travel control according to the embodiment will be described for various cases in which there is an adjacent vehicle traveling in the same direction as the own vehicle in a lane adjacent to the own lane, but the situations are different from each other.

### <Case A: When the Blinkers of the Adjacent Vehicle are not Flashing>

When the blinker of the adjacent vehicle on the own vehicle side is not flashing, a negative determination is made in step S30. Therefore, in step S60, the own vehicle is controlled by the ACC, and step S80 is not executed. That is, the interruption acceptance control for accepting the interruption of the adjacent vehicle into the own lane is not executed.

### <Case B: When the Blinkers of the Adjacent Vehicle are Flashing, but the Interruption is not Allowed>

When the blinkers of the adjacent vehicle on the side of the own vehicle are flashing, but a relative speed Vr and a relative distance Dr are not within the interruption allowable range 80 shown in FIG. 3, an affirmative determination is made in step 30 but a negative determination is made in step S40. Therefore, as in case A above, the own vehicle is controlled by the ACC in step S60, and the interruption acceptance control (S80) is not executed.

### <Case C: When the Blinkers of the Adjacent Vehicle are Flashing and the Interruption is Allowed>

When the blinkers of the adjacent vehicle on the own vehicle side are blinking, the relative speed Vr and the relative distance Dr are within the interruption allowable range 80, and so that the interruption is allowed, a negative determination is first made in step S10 and affirmative determinations are made in steps S20 to S40. Therefore, in step S70, flag F is set to 1, and in step S80, the interruption acceptance control is executed to accept the interruption of the adjacent vehicle into the own lane. Thereafter, an affirmative determination is made in step S10.

### <Case C1: When the Adjacent Vehicle is Executing the Interruption>

An affirmative determination and a negative determination are made in steps S90 and S100, respectively, and in step S110, the preceding vehicle follow-up control is executed using the adjacent vehicle that is executing the interruption as the preceding vehicle, so that the relative distance Dr becomes a set inter-vehicle distance.

<Case C2: When the Adjacent Vehicle does not Interrupt and the Blinkers of the Adjacent Vehicle are Flashing>

Negative determinations are made in steps S90 and S120. Therefore, as long as the relative speed Vr and the relative distance Dr are within the interruption allowable range 80 and so that the interruption is allowed, in step S80, the interruption acceptance control is executed to accept the interruption of the adjacent vehicle into the own lane.

<Case C3: When the Adjacent Vehicle does not Interrupt and the Blinkers of the Adjacent Vehicle are Turned Off>

A negative determination is made in step S90 and an affirmative determination is made in step S120. Therefore, when an elapsed time from the start of the interruption acceptance control for accepting the interruption of the adjacent vehicle into the own lane exceeds the reference value, an affirmative determination is made in step S140 and the flag F is reset to 0 in step S150. Therefore, the interruption acceptance control ends, and the own vehicle is controlled by the ACC in step S60.

Note that even if the adjacent vehicle does not execute the interruption and the blinkers of the adjacent vehicle become unrecognizable after the blinkers are turned off, when an elapsed time from the start of the interruption acceptance control reaches or exceeds the reference value, affirmative determinations are made in steps S120 and S140. Therefore, the interruption acceptance control ends. Furthermore, when the adjacent vehicle completes the interruption, as in the case C3 above, the interruption acceptance control ends and the own vehicle is controlled by the ACC in step S60.

Next, the operation of the embodiment will be explained in comparison with the conventional technique with reference to FIGS. 6 and 7 with respect to the case C above, particularly, the cases where the vehicle speed of the own vehicle 102 is higher than the vehicle speed of the adjacent vehicle 110 and the vehicle speed of the own vehicle 102 is lower than the vehicle speed of the adjacent vehicle 110. Incidentally, in FIGS. 6 and 7, a time point t1 indicates a time point when the blinkers of the adjacent vehicle on the own vehicle side start blinking, and a time point t2 indicates a time point when the adjacent vehicle starts interrupting into the own lane.

A solid line in FIG. 6 shows a change in the vehicle speed Vo of the own vehicle 102 when the vehicle speed of the own vehicle is higher than the vehicle speed Va of the adjacent vehicle 110. A broken line shows a change in the vehicle speed Vo of the own vehicle 102 in the prior art in which the vehicle speed of the own vehicle is reduced at the time point t2 when the adjacent vehicle starts interrupting into the own lane. In the prior art, even if the adjacent vehicle 110 is located ahead of the own vehicle 102 as shown in FIG. 4, the vehicle speed Vo of the own vehicle 102 must be reduced relatively quickly.

On the other hand, according to the embodiment, when it is determined that the relative speed Vr and the relative distance Dr are within the interruption allowable range at or around the time point t1, the interruption acceptance control (S80) is started to accept the interruption of the adjacent vehicle into the own lane. Therefore, as shown by the solid line in FIG. 6, since the vehicle speed Vo of the own vehicle 102 starts to decrease earlier than in the prior art, the vehicle speed Vo may be decreased gently.

A solid line in FIG. 7 shows a change in the vehicle speed Vo of the own vehicle 102 when the vehicle speed of the own vehicle is lower than the vehicle speed Va of the adjacent vehicle 110. A broken line shows the change in vehicle speed Vo of the own vehicle 102 in the prior art in which the vehicle speed Vo is reduced at or just before the time point t2 when the adjacent vehicle starts interrupting into the own lane. In the prior art, even if the adjacent vehicle 110 is located ahead of the own vehicle 102 as shown in FIG. 5, the vehicle speed Vo of the own vehicle 102 decreases relatively quickly and significantly, especially when the relative distance Dr is small. As a result, it is delayed for the vehicle speed Vo to return to an original vehicle speed. Note that this also applies when the relative distance Dr is a negative value.

On the other hand, according to the embodiment, when it is determined that the relative speed Vr and the relative distance Dr are within the interruption allowable range at or around the time point t1, the interruption acceptance control (S80) is started to accept the interruption of the adjacent vehicle into the own lane. Therefore, as shown by the solid line in FIG. 7, the vehicle speed Vo of the own vehicle 102 may be reduced gently, and an amount of reduction may be small, so that the vehicle speed Vo returns to the original speed quickly.

As can be seen from the above description, according to the embodiment, when it is determined that the adjacent vehicle 110 has not executed the interruption and the adjacent vehicle has stopped blinking the blinkers (S90, S110) in a situation where the interruption acceptance control (S80) by the acceleration/deceleration of the own vehicle 102 is being executed (S10), the interruption acceptance control is ended (S150).

Therefore, when the intention to change lanes is withdrawn and the blinkers are turned off before or during a lane change, or when the blinkers are no longer recognized after the blinkers have been turned off, the interruption acceptance control for accepting the adjacent vehicle can be terminated. In addition, as compared to where the interruption acceptance control is terminated when it is determined that the adjacent vehicle is not executing the interruption or when it is determined that the adjacent vehicle has stopped flashing the blinkers, it is possible to accurately determine whether or not the intention to change lanes has been withdrawn. Therefore, it is possible to reduce the possibility that the interruption acceptance control will be terminated unnecessarily.

In particular, according to the embodiment, the interruption acceptance control is ended (S150) when it is determined that the adjacent vehicle 110 is not executing the interruption (S90), the blinkers are turned off (S120) and the time for which the interruption acceptance control is being executed is equal to or greater than the reference value (S140), in a situation where the interruption acceptance control (S80) by the acceleration/deceleration of the own vehicle 102 is being executed (S10).

Therefore, as compared to where it is not determined whether or not the time for which the interruption acceptance control is being executed is equal to or greater than the reference value, it is possible to determine with even higher accuracy whether or not the intention to change lanes has been withdrawn. Therefore, it is possible to further reduce the possibility that the interruption acceptance control will be ended unnecessarily.

Further, according to the embodiment, when the interruption acceptance control (S80) by the acceleration/deceleration of the own vehicle 102 is terminated (S150), the follow-up inter-vehicle distance control is executed (S60). Therefore, when the interruption acceptance control is terminated, the own vehicle can be prevented from approaching the preceding vehicle excessively by the follow-up inter-vehicle distance control.

Further, according to the embodiment, even if it is determined that the adjacent vehicle has not executed the interruption (S90) and the adjacent vehicle has stopped flashing its blinkers (S120) in a situation where the interruption acceptance control is being executed (S10), when it is determined that the lane in which the adjacent vehicle is traveling within a predetermined range in front of the own vehicle merges into the own lane in which the own vehicle is traveling (S130), the interruption acceptance control is continued (S80). Therefore, as compared to where the interruption acceptance control is not continued, it is possible to safely cause the adjacent vehicle to interrupt in front of the own vehicle as the lanes merge.

Although the present disclosure has been described in detail with reference to the specific embodiment, it will be apparent to those skilled in the art that the present disclosure is not limited to the above-described embodiment, and various other embodiments are possible within the scope of the present disclosure.

For example, in the above-described embodiment, when the interruption acceptance control (S80) by the acceleration/deceleration of the own vehicle 102 is terminated (S150), the follow-up inter-vehicle distance control is executed (S60). However, step S60 may be omitted and the follow-up inter-vehicle distance control may not be executed.

Furthermore, at least one of steps S40 and S140 may be omitted.

What is claimed is:

1. A vehicle travel control device comprising a surrounding information acquisition device that acquires information on targets around an own vehicle, and an electronic control unit configured to execute interruption acceptance control by acceleration/deceleration of the own vehicle so that an adjacent vehicle can interrupt in when it is determined that the adjacent vehicle traveling in an adjacent lane is attempting to interrupt in front of the own vehicle by flashing blinkers based on the information on targets acquired by the surrounding information acquisition device, wherein
the electronic control unit is configured to terminate the interruption acceptance control when it is determined that the adjacent vehicle is not executing interruption and the adjacent vehicle has stopped blinking the blinkers in a situation where the interruption acceptance control is being executed.

2. The vehicle travel control device according to claim 1, wherein the electronic control unit is configured to terminate the interruption acceptance control when it is determined that the adjacent vehicle is not executing the interruption, the adjacent vehicle has turned off the blinkers, and a time for which the interruption acceptance control is being executed is equal to or greater than a reference value, in the situation where the interruption acceptance control is executed.

3. The vehicle travel control device according to claim 1, wherein the electronic control unit is configured to execute follow-up inter-vehicle distance control after terminating the interruption acceptance control.

4. The vehicle travel control device according to claim 1, wherein the electronic control unit is configured to acquire map information, and is configured to continue the interruption acceptance control when it is determined, based on the map information, that a lane in which the adjacent vehicle is traveling merges into a lane in which the own vehicle is traveling within a predetermined range in front of the own vehicle, even if it is determined that the adjacent vehicle is not executing the interruption and the adjacent vehicle has stopped blinking the blinkers in a situation where the interruption acceptance control is being executed.

5. The vehicle travel control device according to claim 1, wherein the electronic control unit is configured to execute acceleration/deceleration control of the own vehicle when it is determined that the adjacent vehicle is attempting to interrupt into the lane in which the own vehicle is traveling by flashing the blinkers and it is determined that a relative speed and a relative distance of the adjacent vehicle to the own vehicle are within a preset interruption allowable range.

6. The vehicle travel control device according to claim 5, wherein the electronic control unit is configured to determine that the relative speed and the relative distance are within the preset interruption allowable range when the relative distance is equal to or greater than a reference relative distance, and the reference relative distance is set to be a positive value when the relative speed is less than a negative reference value, and to be a negative value when the relative speed is equal to or greater than the reference value, and so that the smaller the relative speed is, the larger the reference relative distance is.
